(19) United States
(12) Patent Application Publication
(10) Pub. No.: US 2025/0324307 A1
(43) Pub. Date: Oct. 16, 2025

(54) DEVICE AND METHOD FOR ESTIMATING CHANNEL IN WIRELESS COMMUNICATION SYSTEM

(71) Applicant: LG ELECTRONICS INC., Seoul (KR)

(72) Inventors: Hyunmin KIM, Seoul (KR); Kijun KIM, Seoul (KR); Dongsun LEE, Seoul (KR); Byounggill KIM, Seoul (KR); Jongku LEE, Seoul (KR); Taehowan HONG, Seoul (KR); Seju PARK, Seoul (KR)

(73) Assignee: LG ELECTRONICS INC., Seoul (KR)

(21) Appl. No.: 18/862,928

(22) PCT Filed: May 13, 2022
(86) PCT No.: PCT/KR2022/006933

§ 371 Date: Nov. 4, 2024

(51) Int. Cl. H04W 24/10; H04J 13/00; H04L 5/00; H04W 72/12

(52) U.S. Cl. CPC H04W 24/10; H04J 13/004; H04L 5/0051; H04W 72/12

(57) ABSTRACT

In order to estimate a channel in a wireless communication system, a method of operating a user equipment (UE) may comprise receiving from a base station, related to a configuration of reference signals, receiving the reference signals from the base station, generating measurement information based on the reference signals, transmitting the measurement information to the base station, receiving scheduling information from the base station, and receiving data transmitted according to the scheduling information from the base station.

### CROSS-REFERENCE TO RELATED APPLICATION(S)

This application is the National Stage filing under 35 U.S.C. 371 of International Application No. PCT/KR2022/006933, filed on May 13, 2022, the contents of which are all incorporated by reference herein in its entirety.

### TECHNICAL FIELD

The following description relates to a wireless communication system, and to a device and method for estimating a channel in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure can provide a device and method for effectively estimating a channel in a wireless communication system.

The present disclosure can provide a device and method for effectively estimating a channel in a THz frequency band in a wireless communication system.

The present disclosure can provide a device and method for effectively estimating a channel between antenna arrays with very large sizes in a wireless communication system.

The present disclosure can provide a device and method for estimating a multi-antenna channel between two devices existing in a near field in a wireless communication system.

The present disclosure can provide a device and method for estimating a channel by considering the characteristics of a Fresnel region in a wireless communication system.

The present disclosure can provide a device and method for estimating a channel based on a spherical wave front (SWF) model in a wireless communication system.

The present disclosure can provide a device and method for estimating a multi-antenna channel using a relatively small number of reference signals in a wireless communication system.

The present disclosure can provide a device and method for estimating a channel per antenna element based on transmission of reference signals on antenna element group basis in a wireless communication system.

The present disclosure can provide a device and method for securing transmission capacity even in an environment where a line of sight (LOS) component is dominant in a wireless communication system.

The present disclosure can provide a device and method for effectively performing beam focusing in an environment where a propagation distance is within a Fresnel region in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method of operating a user equipment (UE) in a wireless communication system may comprise receiving from a base station, related to a configuration of reference signals, receiving the reference signals from the base station, generating measurement information based on the reference signals, transmitting the measurement information to the base station, receiving scheduling information from the base station, and receiving data transmitted according to the scheduling information from the base station. The measurement information may comprise at least one of information related to a structure of an antenna array of the UE or a reception angle for the reference signals.

As an example of the present disclosure, a method of operating a base station in a wireless communication system may comprise transmitting, to a user equipment (UE), related to a configuration of reference signals, transmitting the reference signals to the UE using an antenna array including a plurality of antenna elements, receiving measurement information generated based on the reference signals from the UE, transmitting scheduling information to the UE, and transmitting data according to the scheduling information. The measurement information may comprise at least one of information related to a structure of an antenna array of the UE or a reception angle for the reference signals.

As an example of the present disclosure, a user equipment (UE) in a wireless communication system may comprise a transceiver and a processor connected to the transceiver. The processor may receive from a base station, related to a configuration of reference signals, receive the reference signals from the base station, generate measurement information based on the reference signals, transmit the measurement information to the base station, receive scheduling information from the base station, and receive data transmitted according to the scheduling information from the base station. The measurement information may comprise at least one of information related to a structure of an antenna array of the UE or a reception angle for the reference signals.

As an example of the present disclosure, a base station in a wireless communication system may comprise a transceiver and a processor connected to the transceiver. The processor may transmit, to a user equipment (UE), related to a configuration of reference signals, transmit the reference signals to the UE using an antenna array including a plurality of antenna elements, receive measurement information generated based on the reference signals from the UE, transmit scheduling information to the UE, and transmit data according to the scheduling information. The measurement information may comprise at least one of information related to a structure of an antenna array of the UE or a reception angle for the reference signals.

As an example of the present disclosure, a communication apparatus may comprise at least one processor and at least one computer memory connected to the at least one processor and configured to store instructions directing operations when executed by the at least one processor. The operations may comprise receiving from a base station, related to a configuration of reference signals, receiving the reference signals from the base station, generating measurement information based on the reference signals, transmitting the measurement information to the base station, receiving scheduling information from the base station, and receiving data transmitted according to the scheduling information from the base station. The measurement information may comprise at least one of information related to a structure of an antenna array of the UE or a reception angle for the reference signals.

As an example of the present disclosure, a non-transitory computer-readable medium storing at least one instruction may comprise the at least one instruction executable by a processor. The at least one instruction may control a device to receive from a base station, related to a configuration of reference signals, receive the reference signals from the base station, generate measurement information based on the reference signals, transmit the measurement information to the base station, receive scheduling information from the base station and receive data transmitted according to the scheduling information from the base station. The measurement information may comprise at least one of information related to a structure of an antenna array of the UE or a reception angle for the reference signals.

The above-described aspects of the present disclosure are only some of the preferred embodiments of the present disclosure, and various embodiments reflecting the technical features of the present disclosure can be derived and understood by a person having ordinary skill in the art based on the detailed description of the present disclosure to be described below.

As is apparent from the above description, the embodiments of the present disclosure have the following effects.

According to the present disclosure, a channel between devices using an antenna array can be effectively estimated.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of an AI device applied to the present disclosure.

FIG. 7 illustrates a method of processing a transmitted signal applied to the present disclosure.

FIG. 8 illustrates an example of a communication structure providable in a 6G system applicable to the present disclosure.

FIG. 9 illustrates an electromagnetic spectrum applicable to the present disclosure.

FIG. 10 illustrates a THz communication method applicable to the present disclosure.

FIG. 11 illustrates an example of a Fresnel region according to an embodiment of the present disclosure.

FIG. 12 illustrates an example of relative arrangement between antennas of a transmission device and a reception device according to an embodiment of the present disclosure.

FIG. 13 illustrates another example of relative arrangement between antennas of a transmission device and a reception device according to an embodiment of the present disclosure.

FIG. 14 illustrates a channel estimation technique according to an embodiment of the present disclosure.

FIG. 15 illustrates examples of various definitions for distances between antenna arrays according to an embodiment of the present disclosure.

FIG. 16 illustrates a concept of deriving a distance between antenna array centers according to an embodiment of the present disclosure.

FIG. 17 illustrates an example of a procedure for transmitting data according to an embodiment of the present disclosure.

FIG. 18 illustrates an example of a procedure for receiving data according to an embodiment of the present disclosure.

FIG. 19 illustrates an example of a procedure for determining channel information according to an embodiment of the present disclosure.

FIG. 20 illustrates an example of a procedure for performing communication using distance information determined by a base station according to an embodiment of the present disclosure.

FIG. 21 illustrates an example of a procedure for performing communication using distance information determined by a terminal according to an embodiment of the present disclosure.

### MODE FOR INVENTION

Following embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment.

In the description of the drawings, procedures or steps which render the scope of the present disclosure unnecessarily ambiguous will be omitted and procedures or steps which can be understood by those skilled in the art will be omitted.

In the entire specification, when a certain portion “comprises” or “includes” a certain component, this indicates that the other components are not excluded, but may be further included unless specially described. The terms “unit”, “-or/er” and “module” described in the specification indicate a unit for processing at least one function or operation, which may be implemented by hardware, software and a combination thereof. In addition, “a or an”, “one”, “the” and similar related words may be used as the sense of including both a singular representation and a plural representation unless it is indicated in the context describing the present specification (especially in the context of the following claims) to be different from this specification or is clearly contradicted by the context.

In this specification, the embodiments of the present disclosure are described with focus on the relationship of data reception and transmission between a base station and a mobile station. Herein, the base station means a terminal node of a network that performs direct communication with the mobile station. In this document, a specific operation, which is described to be performed by a base station, may be performed by an upper node of the base station in some cases.

That is, in a network consisting of a plurality of network nodes including a base station, various operations for communicating with a mobile station may be performed by the base station or network nodes other than the base station. Herein, “base station” may be replaced by such terms as “fixed station”, “Node B”, “eNode B (eNB)”, “gNode B (gNB)”, “ng-eNB”, “advanced base station (ABS)”, or “access point”.

Also, in the embodiments of the present disclosure, “terminal” may be replaced by such terms as “user equipment (UE)”, “mobile station (MS)”, “subscriber station (SS)”, “mobile subscriber station (MSS)”, “mobile terminal” or “advanced mobile station (AMS)”.

In addition, a transmission end refers to a fixed and/or mobile node that provides a data service or a voice service, and a reception end means a fixed and/or mobile node that receives a data service or a voice service. Accordingly, in the case of an uplink, a mobile station may be a transmission end, and a base station may be a reception end. Likewise, in the case of a downlink, a mobile station may be a reception end, and a base station may be a transmission end.

The embodiments of the present disclosure may be supported by standard documents disclosed in at least one of the following radio access systems: an IEEE 802 xx system, a 3rd generation partnership project (3GPP) system, a 3GPP long term evolution (LTE) system, a 3GPP 5th generation (5G) new radio (NR) system and a 3GPP2 system, and in particular, the embodiments of the present disclosure may be supported by the following documents: 3GPP TS (technical specification) 38.211, 3GPP TS 38.212, 3GPP TS 38.213, 3GPP TS 38.321, and 3GPP TS 38.331.

In addition, the embodiments of the present disclosure are applicable to another radio access system but is not limited to the above-described system. As an example, they are applicable to a system applied after a 3GPP 5G NR system and are not limited to a specific system.

That is, obvious steps and parts not described in the embodiments of the present disclosure may be described with reference to the above documents. In addition, all the terms disclosed in this document may be explained by the standard document.

Hereinafter, a preferred embodiment according to the present disclosure will be described in detail with reference to accompanying drawings. Detailed descriptions disclosed below together with accompanying drawings are intended to describe example embodiments of the present disclosure and not intended to show any sole embodiment in which a technical configuration of the present disclosure can be implemented.

In addition, specific terms used in the embodiments of the present disclosure are provided to help understand the present disclosure, and such specific terms may be used in any other modified forms without departing from the technical idea of the present disclosure.

The following technology may be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA) and the like.

For clarity of explanation, the descriptions below are based on a 3GPP communication system (e.g. LTE, NR and the like), but the technical idea of the present disclosure is not limited thereto. LTE may mean a technology after 3GPP TS 36.xxx Release 8. Specifically, the LTE technology after 3GPP TS 36.xxx Release 10 may be referred to as LTE-A, and the one after 3GPP TS 36.xxx Release 13 may be referred to as LTE-A pro. 3GPP NR may mean a technology after TS 38.xxx Release 15. 3GPP 6G may mean a technology after TS Release 17 and/or Release 18. “xxx’ means the specific number of a standard document. LTE/NR/6G may be referred to collectively as 3GPP system.

Contents described in standard documents released earlier than the present disclosure may be referred to for the background art, terms and abbreviations used in the present disclosure. As an example, 36.xxx and 38.xxx standard documents may be referred to.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

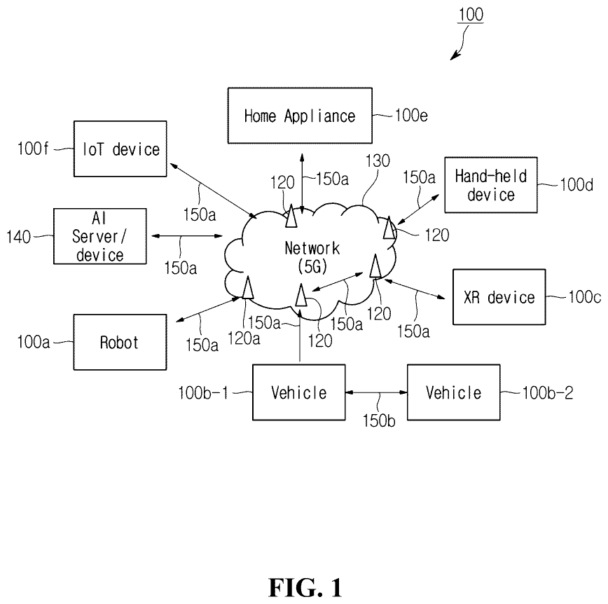

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

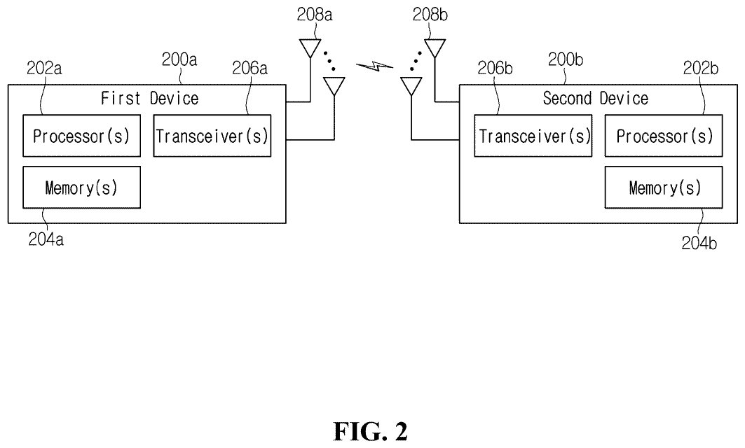

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

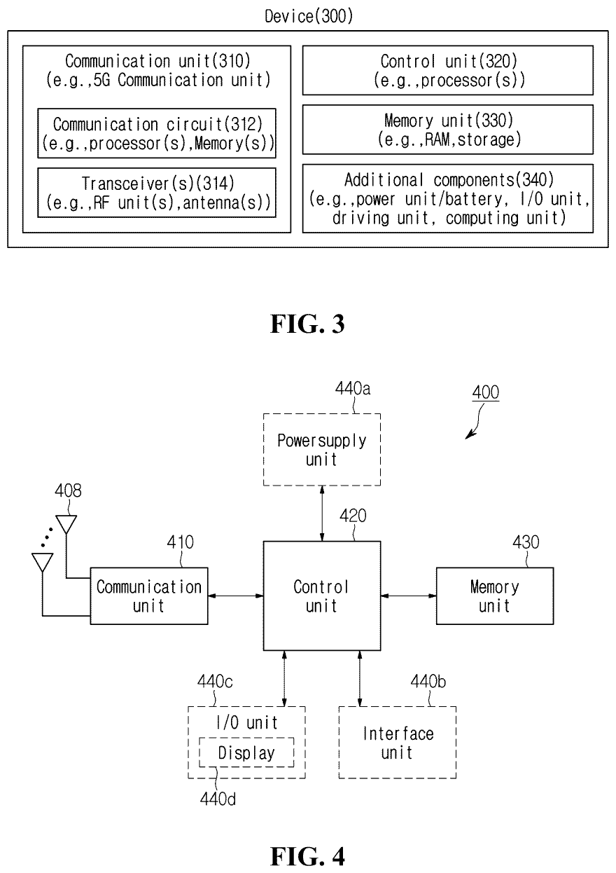

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

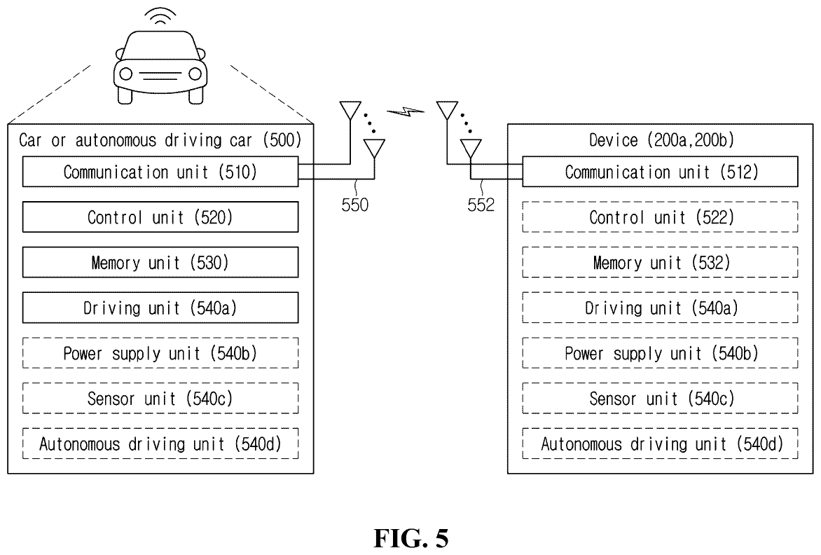

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

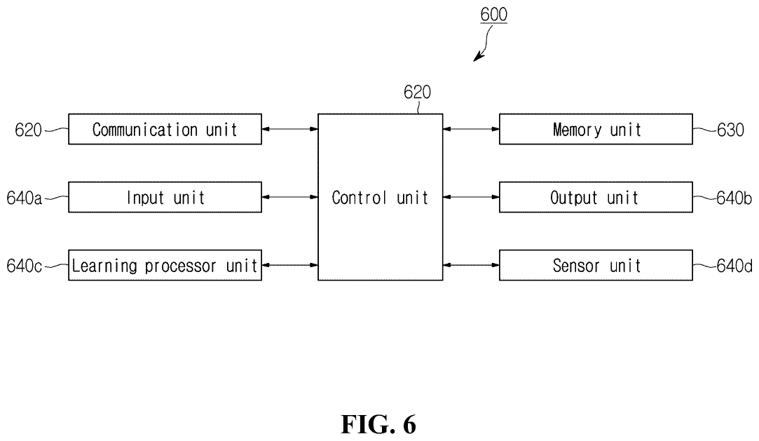

FIG. 6 illustrates an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

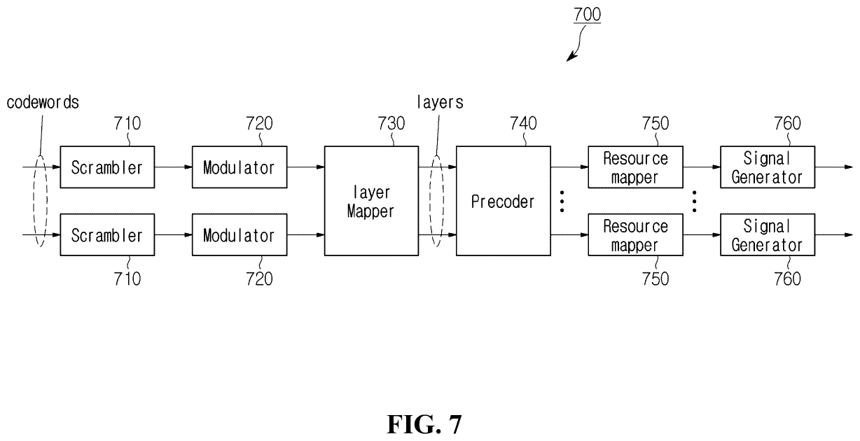

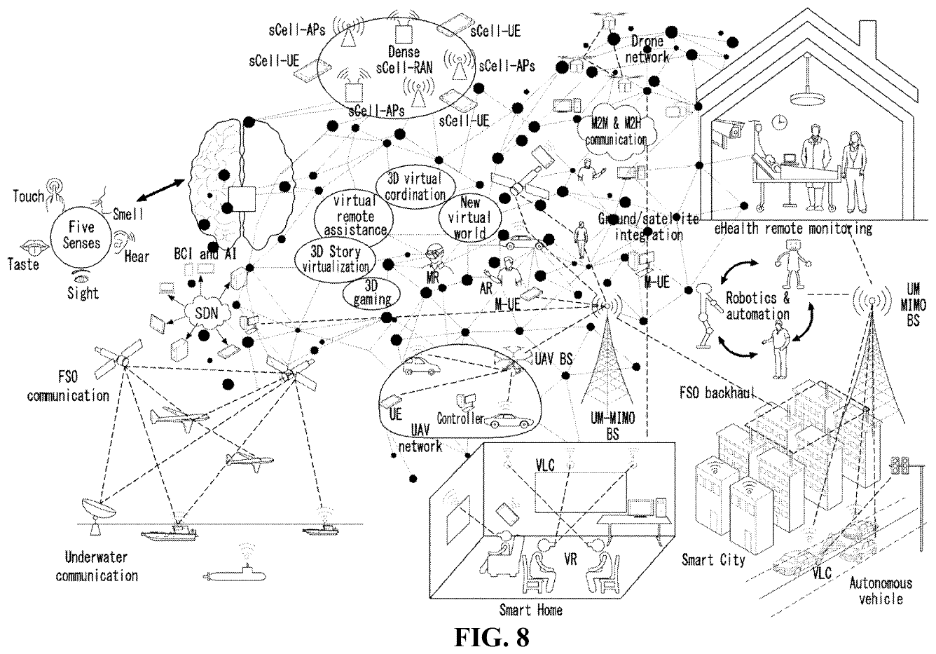

FIG. 7 illustrates a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

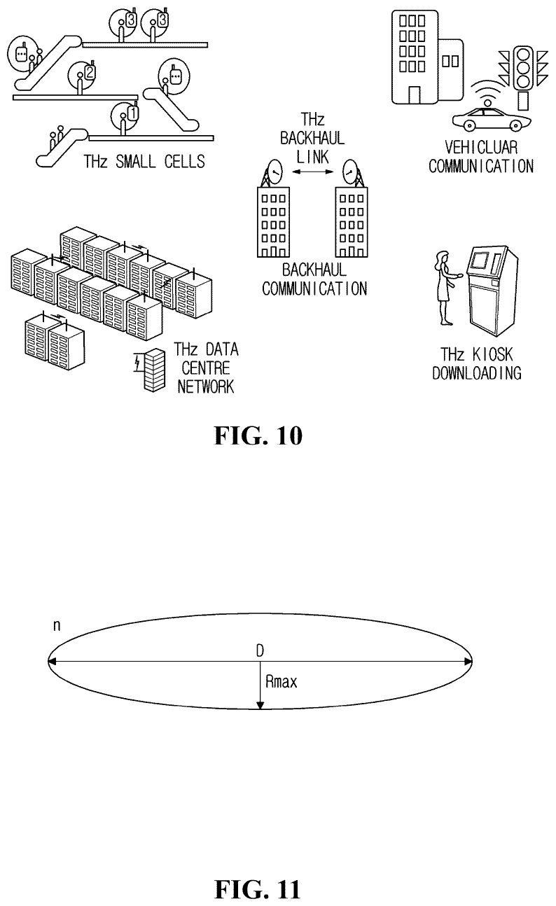

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System-Terahertz (THz) Communication

THz communication is applicable to the 6G system. For example, a data rate may increase by increasing bandwidth. This may be performed by using sub-TH communication with wide bandwidth and applying advanced massive MIMO technology.

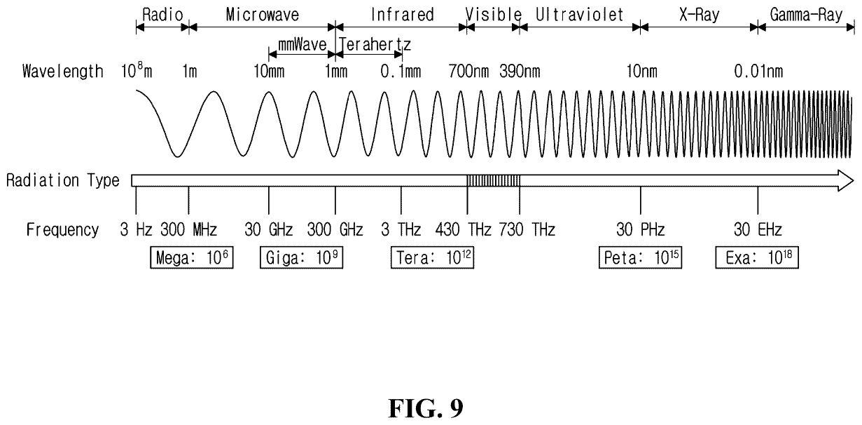

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiments of the Present Disclosure

The present disclosure relates to estimating a channel and determining a precoder in a wireless communication system. Specifically, the present disclosure describes a technique for estimating a channel, determining a suitable precoder based on the estimated channel, and transmitting and receiving a signal when a transmitter and a receiver use antennas with very large sizes. In particular, the present disclosure proposes a technique for more accurately estimating channel information required to determine a precoder.

In environments with severe path loss, such as the Thz band, maximizing beam gain by using a large number of antenna elements is considered as a method of overcoming path loss. However, when transmitting or receiving signals using a large number of antenna elements, there may be limitations in optimizing beam gain if a precoder generated based on the existing PWF (plane wave front) model is used. It is possible to interpret a signal propagation model in a space commonly considered as a Fresnel region not as a PWF model but as a SWF (spherical wave front) model and focus the beam. The Fresnel region is a representation of a near field, and the definition of the Fresnel region is as shown in FIG. 11.

FIG. 11 illustrates an example of a Fresnel region according to an embodiment of the present disclosure. Referring to FIG. 11, the Fresnel region is defined as a three-dimensional prolate ellipsoidal shape that encloses a distance D between a transmitter and a receiver. The largest radius of the three-dimensional prolate ellipsoid is Rₘₐₓ. Rₘₐₓ may be expressed as shown in [Equation 1] below.

$${R}_{max} = \sqrt{n * λ * ( D / 4 )} \qquad [ Equation 1 ]$$

In [Equation 1], Rₘₐₓ denotes the maximum radius of a first-order Fresnel region, n denotes the order of the Fresnel region, λ denotes the wavelength of a radio beam transmitted by an antenna, and D denotes a distance between a transmitter antenna and a receiver antenna.

Referring to [Equation 1], the Fresnel region is closely related to an antenna array size and a communication band. That is, as the frequency band increases such as Thz and the number of antenna elements for beam gain increases, a distance from the Fresnel region becomes longer, and accordingly, it is necessary to assume SWF for signal analysis. For beam focusing based on the SWF model, spatial channel information between all antennas is theoretically required. However, a specific method of acquiring channel information has not been presented, and most existing literatures assume that both direction and position information of a terminal are recognized in the LOS (line of sight) situation, and analyze the beam focusing characteristics assuming that the channel situation of the SWF is ideally acquired based on this.

[Equation 2] below expresses the channel response characteristics according to the antenna array configuration in a SWF-based environment.

$$[ Equation 2 ]$$

$${h}_{SMW , ij} = ρ {e}^{j ϕ} {e}^{- j 2 π \frac{D}{λ}} ( \sqrt{1 + \frac{2 ( {\vec{a}}_{ri} \cdot \vec{{u}_{r}} - {\vec{a}}_{tj} \cdot \vec{{u}_{t}} )}{D} + \frac{{‖ Rot ( θ r , Φ r ) {\vec{a}}_{ri} - {\vec{a}}_{tj} ‖}^{2}}{{D}^{2}}} - 1 )$$

In [Equation 2], h_{smw,ij} denotes a channel value between an antenna element pair, i denotes the index of the antenna element of the transmitter, j denotes the index of the antenna element of the receiver, ρ and Φ denote the channel size response characteristics and phase response characteristics of the transmitter and receiver, D denotes a distance between the center of the transmitter antenna array and the center of the receiver antenna array, λ denotes the radio wave wavelength in the transmission band, aᵢⱼ denotes a position vector for the j-th antenna element at the center position Oₜ of the transmit array antenna array, aᵣᵢ denotes a position vector for the i-th antenna element at the center position Oₜ of the transmit array antenna array, denotes the degree of departure (DoD) from the center of the transmitter antenna array toward the center of the receiver antenna array, \vec{uᵣ} denotes the degree of arrival (DoA) from the center of the transmitter antenna array toward the center of the receiver antenna array, and Rot(θᵣ, Φᵣ) denotes a rotation conversion matrix by the rotation amounts Or and Φr of the receiver.

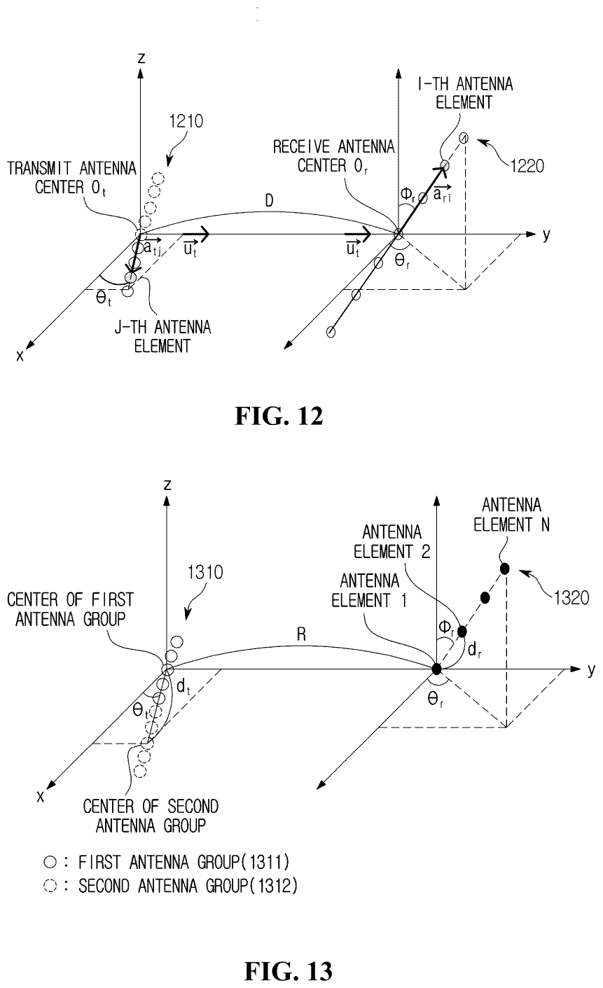

The relationship between variables included in [Equation 2] is as shown in FIG. 12. FIG. 12 illustrates an example of relative arrangement between antennas of a transmission device and a reception device according to an embodiment of the present disclosure. Referring to FIG. 12, a transmit antenna array 1210 of the transmission device includes J antenna elements, and a receive antenna array 1220 of the reception device includes I antenna elements. The transmit antenna array 1210 and the receive antenna array 1220 are separated by a distance D, and the distance D is defined as a distance between the center Oₜ of the transmit antenna array 1210 and the center Oᵣ of the receive antenna array 1220. In the present disclosure, the distance D may be referred to as a propagation distance, a transmission/reception distance, a distance between antennas, etc. In the case of FIG. 12, the transmit antenna array 1210 is arranged on an X-Y plane and is rotated by θₜ in the azimuth direction. The receive antenna array 1220 is rotated by θᵣ and Φᵣ in the azimuth and elevation directions, respectively. At this time, when a signal is transmitted and received in an optimal beam direction, the signal transmission angle DoD is \vec{uₜ}, and the signal reception angle DoA is \vec{uᵣ}.

As an application of the channel response characteristics in the aforementioned SWF environment, assuming a downlink, a UE equipped with a small number of antenna(s) may transmit an uplink reference signal, and a base station may obtain channel information using the reciprocal characteristics of the channel. As an example, if there are multiple terminals each performing communication with one antenna, a method in which the base station estimates the channel using reference signals transmitted simultaneously from the multiple terminals may be considered. However, this method may be difficult to use in practice because it must also consider issues such as RF calibration in terms of practical use.

Beamforming may be performed based on the channel information acquired as above. Beamforming may be performed in various ways. For example, beamforming based on eigenvalue decomposition is possible as in [Equation 3] below.

$${\overline{H}}^{H} \overline{H} = U Λ {U}^{H} \qquad [ Equation 3 ]$$

In [Equation 3], \dot{H} denotes a channel by an LOS component between the transmission device and the reception device, denotes the Hermitian Matrix of, H̅, P is a matrix containing eigenvectors, and Λ denotes a matrix containing eigenvalues. Here, the transmission device (e.g., base station) may use U as an optimal precoder.

In SWF-based MIMO applications, it is very important to obtain information about the channel. However, it is obvious that reference signals as many as the number of antennas should be used to recognize all channels according to a large number of antenna configurations. It may be assumed that reference signals based on channel reciprocity characteristics are used, but in cases where path loss is severe, such as THz, the number of antennas of the terminal should also increase significantly, so many challenges are expected in using them in actual systems due to issues such as the use of a large number of reference signals and RF calibration.

Accordingly, the present disclosure proposes a technology that enables a transmission device to obtain channel information when beam focusing is required in a situation where a terminal and a base station are equipped with a large number of antenna elements and a propagation distance, that is, the transmission and reception distance, is within the Fresnel region. The technology according to various embodiments may be the background of a technology capable of securing transmission capacity even in a situation where the LOS environment is dominant.

According to an embodiment of the present disclosure, an antenna of a transmission device and an antenna of a reception device may be represented as in FIG. 13. Here, the transmission device may be understood as a base station, and the reception device may be understood as a terminal. FIG. 13 illustrates another example of relative arrangement between antennas of a transmission device and a reception device according to an embodiment of the present disclosure. FIG. 13 illustrates position coordinates of antennas of a transmission device and a reception device. In FIG. 13, a reception device (e.g., a terminal) may be located within a Fresnel region.

Referring to FIG. 13, each of a transmit antenna array 1310 of the transmission device and a receive antenna array 1320 of the reception device includes a plurality of antenna elements arranged one-dimensionally. In the receive antenna array 1320, for N antenna elements, a distance between the elements is dᵣ. Two antenna groups 1311 and 1312 are defined from M antenna elements included in the transmit antenna array 1310, and the antenna groups 1311 and 1312 are configured at intervals of dₜ. That is, the antenna groups 1311 may be defined by dividing the antenna elements into bundles as many as the number of groups. Here, the distance between the antenna groups 1311 and 1312 is defined as a distance between the centers of the first antenna group 1311 and the second antenna group 1312.

Each of the antenna arrays 1310 and 1320 is configured as a linear array. With respect to the coordinate system of the transmission device, the transmit antenna array 1310 is arranged on the X-Y plane and is rotated by θₜ in the azimuth direction. With respect to the coordinate system of the transmission device, the receive antenna array 1320 is rotated by θᵣ and Φᵣ in the azimuth direction and the elevation direction, respectively. The first antenna element and the first antenna group 1311 of the receive antenna array 1320 are spaced apart by a distance R, and the distance R is defined as a distance between the center of the first antenna group 1311 and the first antenna element.

In an antenna model such as FIG. 13, channel information may be determined based on the size and phase characteristics of the channel itself, the configuration of the antenna of the transmission device and the antenna of the reception device, and the transmission and reception distance. Here, the size and phase characteristics of the channel itself may not play a significant role as information for beam focusing in the transmission device. This is because, referring to [Equation 3], the size and phase characteristics of the channel itself only affect the value for the overall scale. In particular, since the channel environment in the Fresnel region will be an LOS dominant environment, the characteristics according to the antenna position will mainly cause a difference in the channel due to the phase change caused by the distance difference, which is expressed by the transmission and reception distance. Here, information on the transmission and reception distance (e.g., D in FIG. 12) is not easy to obtain using the existing method. It may be assumed that distance information is obtained by utilizing a triangulation technique using reference signals for positioning, but it may not be appropriate to apply this to the SWF environment. In addition, since the DoA-based positioning algorithm is also an algorithm that assumes PWF, it may not be suitable for the SWF environment. Therefore, it is required to effectively obtain information on the transmission and reception distance in the transmission device and the reception device.

In the example of FIG. 13, the present disclosure exemplifies a one-dimensional ULA (uniform linear array) as the antenna array 1310 of the transmission device. However, various embodiments of the present disclosure may be applied when using an antenna array having a two-dimensional structure as well as a ULA. In this case, each antenna element illustrated in FIG. 13 may be understood as each row or each column of a two-dimensional antenna array. That is, among the antenna elements constituting the rows and columns included in the two-dimensional antenna array, a set of antenna elements belonging to one row or column may correspond to one antenna element illustrated in FIG. 13. In this case, after a procedure according to an embodiment described below is performed for a first dimension (e.g., widthwise or horizontal) and a procedure according to an embodiment described below is performed for a second dimension (e.g., longitudinal or vertical), channel information per antenna element of the two-dimensional antenna array may be determined by combining channel information by two measurement procedures.

At this time, it may be understood that the antenna element groups are defined by dividing the antenna elements of the same dimension included in the antenna array. That is, when two antenna element groups are defined, the two antenna element groups include antenna elements exclusively from each other, and the antenna elements belonging to each group may not overlap.

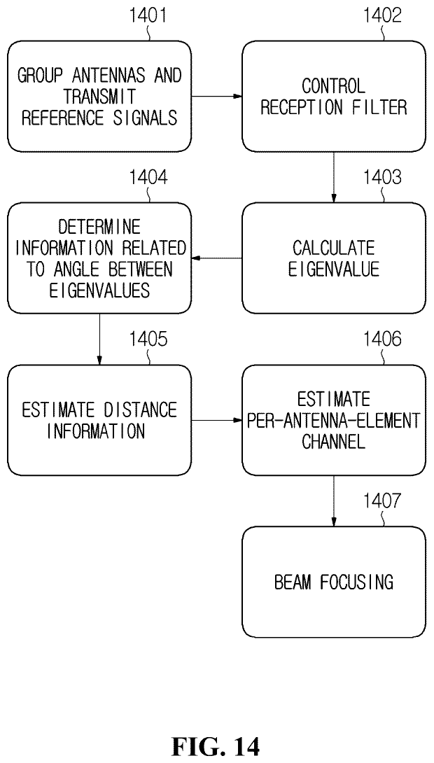

According to various embodiments, in order to estimate information on a transmission/reception distance (hereinafter referred to as “distance information”), the transmission device divides a plurality of antenna elements into a small number of groups and transmits reference signals. At this time, grouping is preferably performed so that a distance between groups (e.g., dₜ in FIG. 13) may be determined. That is, one group includes consecutive antenna elements, and a reference signal may be transmitted on a per-group basis. For example, one group includes at least one antenna element, and two or more groups may be formed. The reception device (e.g., a terminal) may perform the processing described below on reception signals r_{i,1} and r_{i,2} corresponding to the reference signals. Here, r_{i,1} means a signal measured at the i-th receive antenna element for the reference signal transmitted through the j-th transmit antenna group. The concept of a technique for estimating information on the entire channel, including an operation of estimating distance information from the received r_{i,j}, is as shown in FIG. 14. The procedure described with reference to FIG. 14 may be understood as a channel estimation procedure for downlink, and the case where the transmission device (e.g., a base station) uses two antenna groups is exemplified. However, it is obvious that the embodiments described below may also be applied when the transmit antenna array of the transmission device is divided into three or more antenna groups.

FIG. 14 illustrates a channel estimation technique according to an embodiment of the present disclosure. In the procedure described below with reference to FIG. 14, an operating subject is an example, and the operating subject of each step may vary depending on a specific embodiment. Referring to FIG. 14, channel estimation and utilization of the estimated channel proceed in seven steps (1401 to 1407). The operation performed in each step is as follows.

### Step 1 (1401): Group Antennas of a Transmission Device and Transmit Reference Signals

The transmission device divides antenna elements into two groups and transmits reference signals using each antenna group. At this time, the transmitted reference signals may be beamformed using each antenna group. Here, the angle of the beamformed beam may be expressed as θₜ. Through this, DoD information \vec{uₜ} may be obtained. Considering the path loss, the transmission device transmits reference signals at various beam angles, and the reception device measures the received signal strength for the reference signals. The next step may be performed based on a maximum received signal strength.

### Second Step (1402): Control Reception Filter

The reception device performs reception beamforming using an antenna array. That is, the reception device may control the reception filter to match the DoA and obtain DoA information \vec{uᵣ}. Through this, the reception device may obtain channel information as shown in [Equation 4] below. Here, the channel information may include channel values for each receive antenna element when a reception filter suitable for DoA is used.

$${H}_{N \times 2} = [ \begin{matrix}{r}_{11} & {r}_{12} \\ ⋮ & ⋮ \\ {r}_{N 1} & {r}_{N 2}\end{matrix} ] \qquad [ Equation 4 ]$$

In [Equation 4], H_{N×2} denotes a channel matrix, rᵢⱼ denotes a channel value between the j-th antenna element group and the i-th antenna element.

### Third Step (1403): Calculate Eigenvalue by H^{H}H

In the present embodiment, H^{H}H is a 2×2 dimensional matrix, and the amount of calculation is minimized by dividing the antenna elements of the transmission device into two groups. Eigenvalues Δ_{c1} and Δ_{c2} of H^{H}H are calculated. For example, the reception device may obtain the eigenvalues λ_{c1} and λ_{c2} by performing eigenvalue decomposition on H^{H}H. As another example, the reception device may provide channel information to the transmission device, and the transmission device may obtain the eigenvalues λ_{c1} and λ_{c2} by performing eigenvalue decomposition.

In the case of the PWF model, the direction of a counterpart device observed from each antenna element is constant, and a difference between the distances from respective antenna elements to the counterpart device is constant. On the other hand, in the case of the SWF model, the direction of the counterpart device observed from each antenna element is different, and the distances from respective antenna elements to the counterpart device do not have constant differences. Due to this characteristic, in the SWF model, the channels for the multiple antenna elements are independently observed, and the multiplexing gain may vary depending on the distance. That is, even though it is a short distance, the independence between the channels of the antenna elements is secured by the SWF model analysis, and accordingly, the eigenvalues may be obtained by the eigenvalue decomposition.

### Step 4 (1404): Obtain the Information |Γ| Value Related to the Angle Between Eigenvalues

The information related to the angle between eigenvalues may be determined based on the difference between the eigenvalues. First, the difference value is extracted for the eigenvalues λ_{c1} and λ_{c2} as in the following [Equation 5].

$${diff}_{λ} = ( {λ}_{c 1} - {λ}_{c 2} ) / 2 N \qquad [ Equation 5 ]$$

In [Equation 5], diff_{λ} denotes the difference value between eigenvalues, λ_{c1} and λ_{c2} denote eigenvalues obtained from channel information, and N denotes the number of antenna elements of the reception device.

The results of eigenvalues λ_{c1} and λ_{c2} obtained by numerical analysis for H^{H}H may be expressed as [Equation 6] below using the shapes of the transmit antenna and receive antenna, and the number of antenna elements of the reception device.

$${λ}_{c 1} = N + N \vert Γ \vert \qquad [ Equation 6 ]$$

$${λ}_{c 2} = N - N \vert Γ \vert$$

In [Equation 6], λ_{c1} and λ_{c2} denote eigenvalues obtained from channel information, N denotes the number of antenna elements of the reception device, and Γ denotes the cosine value of the angle between the directions of the two eigenvalues. Here, Γ may be defined as in [Equation 7] below.

$$[ Equation 7 ]$$

$$Γ = \frac{1}{N} exp [ \frac{j π}{R λ} ( ( N - 1 ) {d}_{t} {d}_{r} cos {θ}_{t} sin {ϕ}_{r} cos {θ}_{r} - {d}_{t}^{2} {cos}^{2} {θ}_{t} + 2 {Rd}_{t} sin {θ}_{t} ) ] \frac{sin \frac{N π {d}_{t} {d}_{r} cos {θ}_{t} sin {ϕ}_{r} cos {θ}_{r}}{R λ}}{sin \frac{π {d}_{t} {d}_{r} cos {θ}_{t} sin {ϕ}_{r} cos {θ}_{r}}{R λ}}$$

In [Equation 7], Γ denotes the cosine value of the angle between the directions of two eigenvalues, N denotes the number of antenna elements of the reception device, R denotes a distance between the center of the antenna element group of the transmission device and the first antenna element of the reception device, λ denotes the wavelength of the radio wave in the transmission band, dₜ is a distance between antenna element groups, dᵣ denotes a distance between the antenna elements of the reception device, θₜ denotes the azimuth rotation angle of the transmit antenna array, Φᵣ denotes the height rotation angle of the receive antenna array, θᵣ denotes the azimuth rotation angle of the antenna array.

As described above, the |Γ| value is obtained by utilizing the value of diff_{λ}, and R may be inferred from this. In summary, the difference value between eigenvalues may be expressed as [Equation 8] below.

$${diff}_{λ} = \vert Γ \vert \qquad [ Equation 8 ]$$

In [Equation 8], diff_{λ} denotes the difference value between eigenvalues, and Γ is the cosine value of the angle between the directions of two eigenvalues.

### Step 5 (1405): Estimate Distance Information R

If information such as the rotation angle of the antenna and the distance between the antennas is given, the distance R may be estimated. For example, using [Equation 7] and [Equation 8] above, the distance R may be estimated.

Step 6 (1406): Estimate Channel h_{SMW,ij} Between the Transmit Antenna Element and the Receive Antenna Element

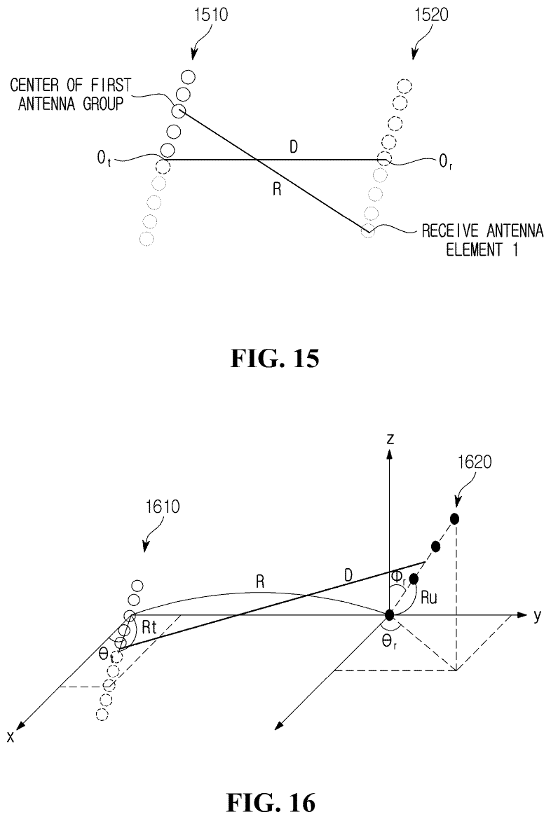

When comparing [Equation 2] and [Equation 7], there is a difference in the definition of the distance between antennas. Referring to FIG. 15, the distance D in [Equation 2] means the distance between the center Oₜ of the transmit antenna array 1410 and the center Oᵣ of the receive antenna array 1420, and the distance R in [Equation 7] means the distance between the center of the first antenna group of the transmit antenna array 1410 and the first antenna element of the receive antenna array 1420. Since the distance D is required for utilizing [Equation 2], it is required to derive the distance D from the distance R.

In order to derive the distance D, a method in which one of the X-axis, Y-axis, and Z-axis of the coordinates of the transmission device is used as a reference for the transmit antenna, a method in which one of the X-axis, Y-axis, and Z-axis of the coordinates of the reception device is used as a reference for the receive antenna, a method in which the coordinates of the transmission device and the reception device are not used as references, etc. may be used. FIG. 16 illustrates a process for determining the distance D based on the method of using the X-axis of the coordinates of the transmission device as the reference for the transmit antenna.

FIG. 16 illustrates a concept of deriving a distance between antenna array centers according to an embodiment of the present disclosure. Referring to FIG. 16, coordinates are set so that a transmit antenna array 1610 is placed on an X-Y plane at an angle of θₜ from the X-axis. Based on the set coordinates, the distance D may be determined using the Euclidean norm of the vector. For example, the distance D may be determined as in [Equation 9] below.

$$D = ‖ {a}_{t} - {a}_{r} ‖ = \sqrt{{( {R}_{t} cos {θ}_{t} - {R}_{u} sin {∅}_{r} cos {θ}_{r} + R )}^{2} + {( {R}_{u} sin {∅}_{r} sin {θ}_{r} - {R}_{t} sin {θ}_{t} )}^{2} + {( {R}_{u} cos {∅}_{r} )}^{2}} \qquad [ Equation 9 ]$$

In [Equation 9], D denotes a distance between the center of the transmit antenna array and the center of the receive antenna array, at denotes a vector indicating the center of the transmit antenna array, aᵣ denotes a vector indicating the center of the receive antenna array, Rₜ denotes a vector from the center of the antenna element group toward the center of the transmit antenna array, Rᵤ denotes a vector from the receive antenna element which is one end of the distance R toward the center of the receive antenna array, θₜ denotes an azimuth rotation angle of the transmit antenna array, Φᵣ denotes a height rotation angle of the receive antenna array, and θᵣ denotes an azimuth rotation angle of the antenna array.

Step 7 (1407): Perform Beam Focusing from Obtained H_{N×M} Information

Various algorithms for beam focusing may be applied. In other words, beam focusing or MIMO technique may be applied in various ways. Since information about channel H may be obtained based on the determined distance D as described above, an algorithm suitable for the environment and purpose may be adopted.

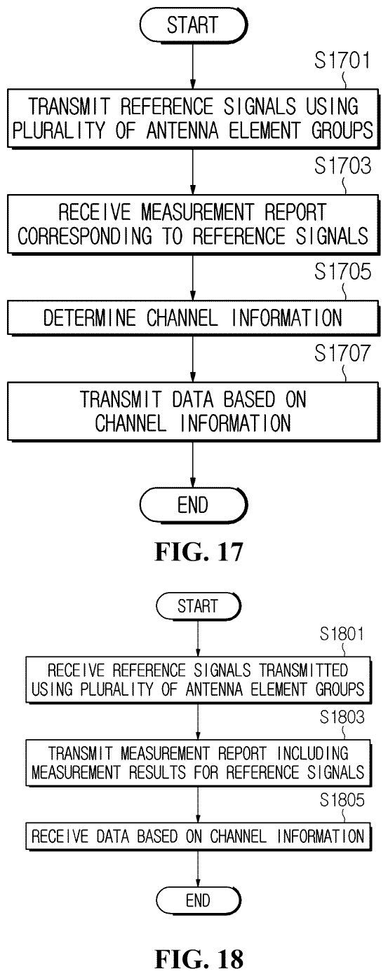

FIG. 17 illustrates an example of a procedure for transmitting data according to an embodiment of the present disclosure. FIG. 17 illustrates a method of operating a device for transmitting data. In the following description, the operating subject is referred to as a ‘device’, and the device may be understood as a base station or a terminal. For example, in the case of downlink communication, the device may be a base station.

Referring to FIG. 17, in step S1701, the device transmits reference signals using a plurality of antenna element groups. That is, the device transmits the reference signals through each of the plurality of antenna element groups determined by grouping antenna elements included in an equipped antenna array. One antenna element group includes a plurality of antenna elements, and the device may beamform a reference signal using one antenna element group. A beamformed reference signal is transmitted from each of the antenna element groups, and at this time, the reference signals transmitted from the plurality of antenna element groups may be transmitted through the same resource or through separate resources. A plurality of reference signals beamformed in different directions for one antenna element group may be transmitted. That is, the device may perform beam sweeping using the antenna element group. At this time, the reference signals beamformed in different directions in one antenna element group may be transmitted through the same resource or through separate resources. Information about the resource through which the reference signals are transmitted may be configured in advance through signaling with a counterpart device. That is, the base station may transmit information related to the configuration of the reference signals and then transmit the reference signals according to the configuration.

In step S1703, the device receives a measurement report corresponding to the reference signals. That is, the counterpart device may perform measurement on the beamformed reference signals using the antenna element groups and transmit the measurement report indicating the measurement result. At this time, the measurement report may indicate a measurement result on the reference signal beamformed in a direction optimally selected by the counterpart device. For example, the measurement report may include channel information per antenna element group (e.g., signal strength, channel matrix, etc.), information on the selected beam (e.g., index of the transmission beam, angle of the reception beam, etc.). According to an embodiment, the measurement report may further include information on the antenna structure of the counterpart device (e.g., distance between antenna elements). Here, since the measurement report expresses the state of the channel measured based on the reference signals, it may be referred to as a measurement report, channel state information (CSI), etc.

In step S1705, the device determines channel information. The channel information determined in this step includes channel values for each antenna element of the device, unlike the channel information included in the measurement report. To this end, the device may determine a distance value between a center of the antenna array of the device and a center of the antenna array of the counterpart device based on information obtained by receiving the measurement report, and determine channel values for each antenna element pair based on the determined distance value. For example, in addition to the distance value, at least one of a position vector for each antenna element relative to the center of the antenna array, DoA and DoD for an optimal beam direction, or a wavelength of a signal may be further used to determine the channel values for each antenna element pair.

In step S1707, the device transmits data based on channel information. Since channel values between antenna elements of the device and antenna elements of the counterpart device are determined, the device may apply various techniques for beamforming or precoding. Specifically, the device may determine a transmission method (e.g., rank, precoder, etc.) for data transmission, allocate resources, transmit scheduling information (e.g., downlink control information (DCI)), and generate and transmit a data signal.

In the embodiment described with reference to FIG. 17, the device determines channel information per antenna element. At this time, according to another embodiment, the distance value between the centers of the antenna arrays may be determined by the counterpart device and then fed back. In this case, the device may transmit information necessary to determine the distance value to the counterpart device and receive the determined distance value. For example, the information provided to the counterpart device may include at least one of information about a selected beam (e.g., an angle of a transmission beam) and information about an antenna structure (e.g., a distance between antenna elements).

FIG. 18 illustrates an example of a procedure for receiving data according to an embodiment of the present disclosure. FIG. 18 illustrates a method of operating a device for receiving data. In the following description, an operating subject is referred to as a ‘device’, and the device may be understood as a base station or a terminal. For example, in the case of downlink communication, the device may be a terminal.

Referring to FIG. 18, in step S1801, the device receives reference signals transmitted using a plurality of antenna element groups. That is, a counterpart device transmits reference signals through each of a plurality of antenna element groups determined by grouping antenna elements included in an equipped antenna array. Information about resources through which the reference signals are received may be configured in advance through signaling with the counterpart device. At this time, the device may perform reception beamforming for the reference signals. Then, the device may perform measurements on the reference signals, select an optimal beam direction, and generate measurement information for the selected beam direction. Although not shown in FIG. 18, the terminal may receive information related to the configuration of the reference signals and then receive the reference signals according to the configuration.

In step S1803, the device receives a measurement report including measurement results for the reference signals. The measurement report may indicate measurement results for reference signals beamformed in a direction optimally selected by the device. For example, the measurement report may include channel information per antenna element group (e.g., signal strength, channel matrix, etc.) and information about the selected beam (e.g., index of a transmission beam, angle of a reception beam, etc.). According to an embodiment, the measurement report may further include information about the antenna structure of the device (e.g., distance between antenna elements). Here, since the measurement report expresses the state of a channel measured based on the reference signals, it may be referred to as measurement information, channel state information, etc.

In step S1805, the device receives data based on the channel information. The counterpart device may determine channel values for each antenna element based on the measurement report, perform scheduling based on the determined channel values, and transmit data based on the result of the scheduling. Specifically, the device may receive scheduling information (e.g., DCI) and receive a data signal.

In the embodiment described with reference to FIG. 18, the device transmits the measurement report and then receives data. At this time, according to another embodiment, the device may transmit a distance value between centers of antenna arrays to the counterpart device. In this case, the device may receive information necessary to determine the distance value from the counterpart device and determine the distance value. For example, the device may receive at least one of information about a selected beam (e.g., an angle of a transmission beam) and information about an antenna structure of the counterpart device (e.g., a distance between antenna elements) from the counterpart device.

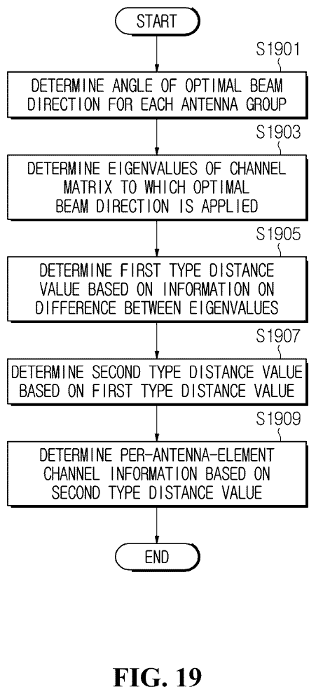

FIG. 19 illustrates an example of a procedure for determining channel information according to an embodiment of the present disclosure. FIG. 19 illustrates a method of operating a device for determining a distance between antenna arrays and channel information per antenna element. In the following description, an operating subject is referred to as a ‘device’, and the device may be understood as a base station or a terminal.

Referring to FIG. 19, in step S1901, the device determines an angle of an optimal beam direction for each antenna group. If the device is a base station, the base station may confirm a reception beam direction according to information included in a measurement report received from a terminal. If the device is a terminal, the terminal may confirm a transmission beam direction through a message received from the base station.

In step S1903, the device determines eigenvalues of a channel matrix to which an optimal beam direction is applied. The channel matrix includes channel values between an antenna element group of a transmission device and an antenna element of a reception device. Specifically, each column of the channel matrix corresponds to each antenna element group, and each row corresponds to each antenna element. The device may determine eigenvalues as many as the number of antenna element groups by performing eigenvalue decomposition on the Hermitian matrix_of the channel matrix and the product of the channel matrices. If the device is a base station, the base station may obtain information on the channel matrix through the measurement report and then determine the eigenvalues.

In step S1905, the device determines a first type distance value based on information on a difference between the eigenvalues. Here, the first type distance value means a distance between the center of the antenna element group of the transmission device and the designated antenna element of the reception device. For example, the first type distance value may be understood as R of FIG. 15. Specifically, the device may calculate a difference value between the eigenvalues, and calculate a distance value (e.g., a cosine value for the angular difference) based on the angular difference between the eigenvalues based on the difference value. Thereafter, the device may determine the first type distance value based on information about the structure of the antennas (e.g., the distance between the antenna element groups of the transmission device, the distance between the antenna elements of the reception device, the antenna array angle, the number of antenna elements) from the distance value based on the angular difference. For example, the device may determine the first type distance value based on a relationship such as [Equation 7].

In step S1907, the device determines a second type distance value based on the first type distance value. The second type distance value means a distance between the center of the antenna array of the transmission device and the center of the antenna array of the reception device. For example, the second type distance value may be understood as D of FIG. 15. The first type distance value and the second type distance value have a relationship that depends on the structure of the antenna arrays. Specifically, the device may determine the second type distance value based on information about the structure of the antennas (e.g., the distance between antenna element groups of the transmission device, the distance between antenna elements of the reception device, the antenna array angle, the number of antenna elements) from the first type distance value. For example, the device may determine the second type distance value based on a relationship such as [Equation 9].

In step 1909, the device determines channel information per antenna element based on the second type distance value. Here, the channel information per antenna element includes channel values for each of pairs of antenna elements of the transmission device and antenna elements of the reception device. The device may determine channel information per antenna element based on information about the structure of the antenna arrays, channel response characteristics, wavelengths of signals, etc. For example, the device may determine channel per antenna element information based on a relationship such as [Equation 2]

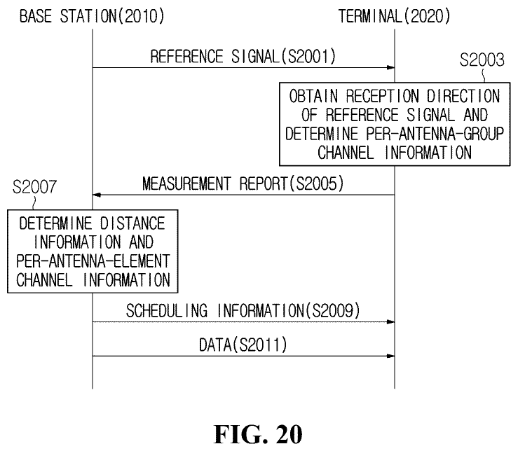

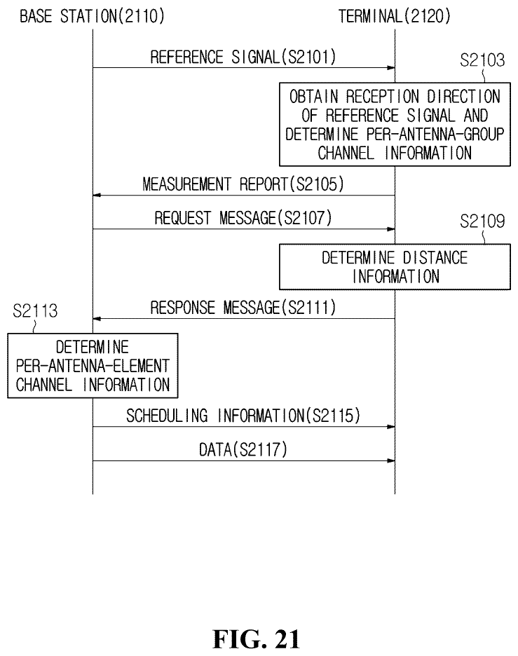

According to the various embodiments described above, channel information for communication between devices using a plurality of antenna elements may be determined. At this time, a series of operations for determining the channel information may be performed by the base station, the terminal, or cooperation between the base station and the terminal. In particular, calculation of the distance value (e.g., D in FIG. 15) between antenna arrays used for determining the channel information may be performed by the base station or the terminal. Various embodiments in which the subjects performing the operations are different are described below with reference to FIGS. 20 and 21.

FIG. 20 illustrates an example of a procedure for performing communication using distance information determined by a base station according to an embodiment of the present disclosure. FIG. 20 illustrates a case where a distance value between antenna arrays is determined by a base station.

Referring to FIG. 20, in step S2001, a base station 2010 transmits reference signals to a terminal 2020. The reference signals are beamformed using antenna element groups determined by grouping antenna elements within an antenna array of the base station 2010. That is, the base station 2010 divides the antenna array into a plurality of sub antenna arrays and beamforms the reference signals using each sub antenna array. Here, the reference signal may include at least one of a CSI-RS (channel state information-reference signal), a DMRS (demodulation reference signal), or an SSB (synchronization signal block).

In step S2003, the terminal 2020 obtains the reception direction of the reference signal and determines channel information per antenna group. That is, the terminal 2020 performs reception beamforming on the reference signals, confirms the reception timing of the reference signal having a maximum signal reception strength, and then determines the direction of the reception beam used at the confirmed reception timing as the reception direction. Then, the terminal 2020 may determine channel information per antenna group based on the reception values of the reference signal measured at the confirmed reception timing. For example, the channel information may be determined as in [Equation 4].

In step S2005, the terminal 2020 transmits a measurement report to the base station 2010. The measurement report may include information determined using the reference signals transmitted in step S2001 and information related to the structure of the antenna array of the terminal 2020. For example, the measurement information may include at least one of channel information per antenna group, reception direction information of the reference signal, information indicating the reception timing confirmed in step S2003, and information on a distance between the antenna elements of the terminal 2020. Here, since the measurement report expresses the state of the channel measured based on the reference signals, it may be referred to as measurement information, channel state information, etc.

In step S2007, the base station 2010 determines distance information and channel information per antenna element. Here, the distance information means the distance between the center of the antenna array of the base station 2010 and the center of the antenna array of the terminal 2020 (e.g., D in FIG. 15). Then, the base station 2010 may determine channel information per antenna element based on the distance information. For example, the channel information per antenna element may be determined as in [Equation 2].

In step S2009, the base station 2010 transmits scheduling information to the terminal 2020. That is, the base station 2010 determines a configuration (e.g., rank, precoder, etc.) to be applied to data transmission to the terminal 2020 using the channel information per antenna element determined in step S2007, and transmits scheduling information (e.g., DCI) indicating at least a part of the configuration. For example, the scheduling information may include a rank indicator, resource allocation information, etc.

In step S2011, the base station 2010 transmits data to the terminal 2020. The base station 2010 may transmit data based on the scheduling information transmitted in step S2009. Specifically, the base station 2010 may map and precode a transmission signal to a resource using the rank and precoder determined based on the channel information, and then transmit the precoded signal. Here, precoding may be understood to include at least one of digital beamforming or analog beamforming.

FIG. 21 illustrates an example of a procedure for performing communication using distance information determined by a terminal according to an embodiment of the present disclosure. FIG. 21 shows a case where a distance value between antenna arrays is determined by a terminal.

Referring to FIG. 21, in step S2101, a base station 2110 transmits reference signals to a terminal 2120. The reference signals are beamformed using antenna element groups determined by grouping antenna elements within an antenna array of the base station 2110. That is, the base station 2110 divides the antenna array into a plurality of sub antenna arrays and beamforms reference signals using each sub antenna array. Here, the reference signal may include at least one of CSI-RS, DMRS or SSB.

In step S2103, the terminal 2120 obtains the reception direction of the reference signal and determines channel information per antenna group. That is, the terminal 2120 performs reception beamforming on the reference signals, confirms the reception timing of the reference signal having a maximum signal reception strength, and then determines the direction of the reception beam used at the confirmed reception timing as the reception direction. Then, the terminal 2120 may determine channel information per antenna group based on the reception values of the reference signal measured at the confirmed reception timing. For example, the channel information may be determined as in [Equation 4].

In step S2105, the terminal 2120 transmits a measurement report to the base station 2110. The measurement report may include information determined using the reference signals transmitted in step S2101. For example, the measurement information may include at least one of channel information per antenna group or information indicating the reception timing confirmed in step S2103. Here, information indicating the reception timing may be understood as information indicating the optimal transmission beam selected by the terminal 2120 or the direction of the transmission beam. Here, since the measurement report expresses the state of the measured channel based on the reference signals, it can be referred to as measurement information, channel state information, etc.

In step S2107, the base station 2110 transmits a request message to the terminal 2120. The request message is transmitted to request the terminal 2120 to determine and feed back distance information. That is, the base station 2110 transmits the request message to provide information necessary for determining distance information and to request to determine and provide distance information. For example, the request message may include information related to the direction of the optimal transmission beam selected by the terminal 2120 and information related to the structure of the antenna array of the base station 2110.

In step S2109, the terminal 2120 determines distance information. Here, the distance information means a distance between the center of the antenna array of the base station 2110 and the center of the antenna array of the terminal 2120 (e.g., D in FIG. 15). For example, the terminal 2120 may determine distance information using a relationship such as [Equation 7].

In step S2111, the terminal 2120 transmits a response message to the base station 2110. The terminal 2120 transmits a response message corresponding to the request message received in step S2107. The response message includes the distance information determined in step S2109.

In step S2113, the base station 2110 determines channel information per antenna element. Then, the base station 2110 may determine channel information per antenna element based on the distance information. For example, the channel information per antenna element may be determined as in [Equation 2].

In step S2115, the base station 2110 transmits scheduling information to the terminal 2120. That is, the base station 2110 determines a configuration (e.g., rank, precoder, etc.) to be applied to data transmission to the terminal 2120 using the channel information per antenna element determined in step S2107, and transmits scheduling information (e.g., DCI) indicating at least a part of the configuration. For example, the scheduling information may include a rank indicator, resource allocation information, etc.

In step S2117, the base station 2110 transmits data to the terminal 2120. The base station 2110 may transmit data based on the scheduling information transmitted in step S2115. Specifically, the base station 2110 may map and precode a transmission signal to a resource using the rank and precoder determined based on the channel information, and then transmit the precoded signal. Here, precoding may be understood to include at least one of digital beamforming or analog beamforming.

In the embodiments described with reference to FIGS. 20 and 21, the base station transmits the reference signal to the terminal. In this case, according to an embodiment, the reference signal may be transmitted aperiodically. In this case, the reference signals per antenna element group may be divided by orthogonal covering codes (OCCs) per port, or by resources based on at least one of CDM, SDM, TDM or FDM. In other words, the base station may transmit the reference signals aperiodically in order to obtain DoD information (e.g.,) with the UE. The base station may configure two or more antenna element groups, determine reference signals to be transmitted to the UE simultaneously using a plurality of antenna groups, and explicitly inform the UE of all separated port information, which is divided by resources and used for transmitting the reference signals. For example, the base station may indicate at least one of per-reference-signal port information, resource information, or OCC information through signaling (e.g., DCI, MAC, or RRC).

According to another embodiment, unlike the case where separate reference signals are configured for each antenna element group, reference signals of a plurality of antenna element groups may be transmitted using one configuration for the reference signal. In this case, the terminal may distinguish the reference signals transmitted from each antenna element group through virtual port distinction according to the transmission mode, and perform measurement for each antenna element group. For example, the terminal may identify the reference signal of each antenna element group according to a predefined rule or implicit instruction. Specifically, the terminal may determine the antenna port corresponding to each antenna element group used, resource location, etc. without explicit signaling. For example, based on the configuration of the antenna element groups and the reference signal, the terminal may distinguish the per-antenna-element-group reference signals based on the ports for the received reference signals, and perform measurement for each antenna element group. At this time, the information on the antenna element group may include at least one of the number of antenna element groups, the number of ports for each antenna element group, or the port number for each antenna element group.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving, from a base station, information related to a configuration of reference signals;
receiving the reference signals from the base station;
generating measurement information based on the reference signals;
transmitting the measurement information to the base station;
receiving scheduling information from the base station; and
receiving data transmitted according to the scheduling information from the base station,
wherein the measurement information comprises at least one of information related to a structure of an antenna array of a user equipment (UE) or a reception angle for the reference signals.

2. The method of claim 1, wherein the reference signals are transmitted to generate channel information per antenna element group of a first antenna element group and a second antenna element group defined by dividing antenna elements included in the antenna array without overlapping.

3. The method of claim 2, wherein the measurement information further comprises the channel information per antenna element group.

4. The method of claim 1,
wherein the reference signals comprise a first reference signal transmitted from the first antenna element group and a second reference signal transmitted from the second antenna element group,
wherein the method further comprises:
receiving, from the base station, a first message including at least one of a transmission angle for the first reference signal, a transmission angle for the second reference signal or information related to a structure of an antenna array of the base station; and
transmitting, to the base station, a second message including a first type distance which is a distance between the first antenna element group and one antenna element of the UE.

5. The method of claim 4, further comprising:
determining eigenvalues for the channel information per antenna element group; and
determining the first type distance, which is the distance between the first antenna element group and the one antenna element of the UE, based on the eigenvalues.

6. The method of claim 1, wherein the information related to the configuration of the reference signals comprises at least one of port information allocated to each antenna element group, resource information allocated to each antenna element group or orthogonal covering code (OCC) information allocated to each antenna element group.

7-12. (canceled)

13. A user equipment (UE) comprising:
a transceiver; and
a processor connected to the transceiver,
wherein the processor is configured to:
receive from a base station, information related to a configuration of reference signals;
receive the reference signals from the base station;
generate measurement information based on the reference signals;
transmit the measurement information to the base station;
receive scheduling information from the base station; and
receive data transmitted according to the scheduling information from the base station,
wherein the measurement information comprises at least one of information related to a structure of an antenna array of the UE or a reception angle for the reference signals.

14. A base station comprising:
a transceiver; and
a processor connected to the transceiver,
wherein the processor is configured to:
transmit, to a user equipment (UE), information related to a configuration of reference signals;
transmit the reference signals to the UE using an antenna array including a plurality of antenna elements;
receive measurement information generated based on the reference signals from the UE;
transmit scheduling information to the UE; and
transmit data according to the scheduling information,
wherein the measurement information comprises at least one of information related to a structure of an antenna array of the UE or a reception angle for the reference signals.

15-16. (canceled)

17. The base station of claim 14, wherein the reference signals are transmitted to generate channel information per antenna element group of a first antenna element group and a second antenna element group defined by dividing antenna elements included in the antenna array without overlapping.

18. The base station of claim 17, wherein the measurement information further comprises the channel information per antenna element group.

19. The base station of claim 17, further comprising:
determining eigenvalues for the channel information per antenna element group;
determining a first type distance, which is a distance between the first antenna element group and one antenna element of the UE, based on the eigenvalues;
determining a second type distance, which is a distance between a center of an antenna array of the base station, and a center of an antenna array of the UE based on the first type distance; and
determining the channel information per antenna element group based on the second type distance.

20. The base station of claim 14,
wherein the reference signals comprise a first reference signal transmitted from the first antenna element group and a second reference signal transmitted from the second antenna element group,
wherein the method further comprises:
transmitting, to the UE, a first message including at least one of a transmission angle for the first reference signal, a transmission angle for the second reference signal or information related to a structure of an antenna array of the base station;
receiving, from the UE, a second message including a first type distance which is a distance between the first antenna element group and one antenna element of the UE;
determining a second type distance which is a distance between a center of an antenna array of the base station and a center of an antenna array of the UE based on the first type distance; and
determining the channel information per antenna element group based on the second type distance.

21. The base station of claim 14, wherein the information related to the configuration of the reference signals comprises at least one of port information allocated to each antenna element group, resource information allocated to each antenna element group or orthogonal covering code (OCC) information allocated to each antenna element group.
